(19) United States
(12) Patent Application Publication
(10) Pub. No.: US 2013/0220961 A1
(43) Pub. Date: Aug. 29, 2013

(54) RAILCAR CUSHIONING DEVICE

(71) Applicant: ALLEN SMITH, MECHANICSBURG, PA (US)

(72) Inventor: ALLEN SMITH, MECHANICSBURG, PA (US)

(73) Assignee: AMSTED RAIL COMPANY, INC., CHICAGO, IL (US)

(21) Appl. No.: 13/408,502

(22) Filed: Feb. 29, 2012

(51) Int. Cl. B61G 9/08; F16F 9/19; B61G 11/12

(52) U.S. Cl. 213/43; 188/315

(57) ABSTRACT

A railcar cushioning device has a hydraulic cylinder holding pressurized fluid. The cylinder has a cylinder body with an inner chamber and a reservoir chamber. A piston is movably positioned in the inner chamber. The cylinder body has a bleed opening allowing bleed flow from the inner chamber to the reservoir chamber. A bleed orifice valve in the bleed opening has a valve housing and a poppet received in the valve housing that moves to allow and restrict fluid flow through a bleed flow path based on the pressure of the fluid. The poppet has an orifice channel allowing a restricted fluid flow through the valve housing when the pressure in the inner chamber is greater than the pressure in the reservoir chamber.

### BACKGROUND OF THE INVENTION

The subject matter herein relates generally to railcar cushioning devices for absorbing buff and draft impacts.

Cushioning units are conventionally mounted in pockets at the ends of the center sill of a railcar. The railcars are joined together to form a train by pairs of knuckle couplers connected to the cushioning units. The train may be 50 or more cars long and drawn by one or more locomotives. The pairs of knuckle couplers provide approximately 2 inches of free movement or slack between adjacent cars. This slack permits the railcars limited movement toward and away from each other in response to train action events including locomotive traction and braking, differences in braking forces of adjacent cars and gravity-induced movement of the cars as the train moves onto and away from inclines.

Train action events subject the couplers of joined cars to buff and draft impacts which, if undamped, are transmitted directly to the railcars and subject the cars and lading to undesirable high accelerations. The accelerations can injure lading on the railcars. Additionally, trains are made up in rail yards, conventionally by rolling individual cars into stationary cars so that the knuckle couplers are engaged. Relative high speed rolling of cars against stationary cars subjects both cars to high buff impacts which are capable of injuring lading on the cars.

Rail car cushioning units have problems efficiently cushioning impacts from train action events, both in buff and draft, and have problems efficiently cushion high buff impacts experienced during train make-up.

There is a desire to reduce the size of the cushioning units. Such reduction in size reduces the amount of hydraulic fluid in the cushioning unit. As a result, the bleed rate of the cushioning unit needs to be lower to ensure that the return stroke for the cushioning unit to return to a neutral position is within a prescribed time period, such as between 60-90 seconds. To reduce the bleed rate, the size of the bleed orifice is reduced. Problems arise with clogging by debris or contaminants in small bleed orifices. Because of the small size of the bleed orifices there is insufficient force acting on the contaminants to force them out of the orifice.

A need remains for a cushioning unit that uses a small bleed orifice and that reduces the occurrence of clogging of the bleed orifice.

### BRIEF DESCRIPTION OF THE INVENTION

In one embodiment, a railcar cushioning device is provided having a piston being coupled to a coupler of a railcar and movable from a neutral position and a hydraulic cylinder holding pressurized fluid. The cylinder has a cylinder body with an inner chamber interior of the cylinder body and a reservoir chamber exterior of the cylinder body. The piston is positioned in the inner chamber and a fluid flow path allows fluid flow from the inner chamber to the reservoir chamber as the piston is moved from the neutral position. The cylinder body has a bleed opening therethrough allowing bleed flow from the inner chamber to the reservoir chamber as the piston returns to the neutral position. A bleed orifice valve is received in the bleed opening and has a valve housing having a bleed flow path therethrough. The bleed orifice valve has a poppet received in the valve housing that moves to allow and restrict fluid flow through the bleed flow path based on the pressure of the fluid in the inner chamber and the reservoir chamber. The poppet has an orifice channel allowing a restricted fluid flow through the valve housing when the pressure in the inner chamber is greater than the pressure in the reservoir chamber.

Optionally, the rate of bleed flow through the valve housing may be controlled by the size of the orifice channel. In a draft mode, the poppet may abut against a midwall of the valve housing such that the orifice channel is the only flow path through the valve housing. In a buff mode, the poppet may be positioned away from the midwall increasing the size of the bleed flow path to allow greater flow through the bleed orifice valve. In a draft mode, the bleed flow may be in a direction from the inner chamber to the reservoir chamber and is restricted. In a buff mode, the fluid flow through the bleed orifice valve may be in an opposite direction from the reservoir chamber to the inner chamber.

Optionally, the bleed orifice valve may be self-cleaning during buff impacts by reversing the fluid flow direction through the valve housing and increasing the size of the bleed flow path to flush debris from the valve housing.

Optionally, the valve housing may include a poppet cavity having a midwall at an end of the poppet cavity. The poppet may have a front end with the orifice channel formed in the front end. In a draft mode, the pressure of the fluid may force the front end against the midwall such that the orifice channel defines the only flow path through the valve housing. In a buff mode, the pressure of the fluid may force the poppet away from the midwall to flush debris from the orifice channel.

Optionally, the piston may be positioned forward of the bleed orifice valve when the piston is in the neutral position and the bleed orifice valve may allow reverse bleed flow therethrough to allow the piston to move in a buff direction until the piston covers the bleed opening. A second bleed opening and a second bleed orifice valve may be provided with the bleed orifice valves being axially offset.

In another embodiment, a railcar cushioning device for cushioning both buff and draft impacts is provided. The cushioning device includes a cylinder having a rear head at one cylinder end and a front head at an opposed cylinder end. The cylinder has walls defining an exterior cylinder and an inner piston cylinder within the exterior cylinder. A piston is located in the inner piston cylinder and is movable from a neutral position between the heads. The cylinder has a high pressure chamber in the inner piston cylinder between the piston and the rear head and a low pressure chamber in the inner piston cylinder between the piston and the front head. The piston separates the high and low pressure chambers. The cylinder has a reservoir chamber between the inner piston cylinder and the exterior cylinder. The reservoir chamber is in fluid communication with both the high pressure chamber and the low pressure chamber. Pressurized fluid is allowed to flow in the chambers and the pressurized fluid normally holds the piston in the neutral position. A high pressure fluid flow path is defined between the high pressure chamber and the reservoir chamber. A buff valve is received in the high pressure fluid flow path and the pressurized fluid moves through the high pressure fluid flow path when a buff impact occurs. A low pressure fluid flow path is defined between the low pressure chamber and the reservoir chamber. A draft valve is received in the low pressure fluid flow path for controlling fluid flow through the low pressure fluid flow path. A bleed flow path is defined between the low pressure chamber and the reservoir chamber. A bleed orifice valve is received in the bleed flow path. The fluid moves through the bleed flow path after the buff impact occurs as the piston returns to the neutral position. The bleed orifice valve has a poppet movable within a valve housing to control flow of the fluid through the valve housing.

### BRIEF DESCRIPTION OF THE DRAWINGS

FIG. 1 illustrates a railcar cushioning device formed in accordance with an exemplary embodiment.

FIG. 2 is a cross sectional view of the railcar cushioning device showing a cylinder and a piston.

FIG. 3 is a partial sectional view of a portion of the railcar cushioning device.

FIG. 4 is a cross sectional view of a bleed orifice valve for the cylinder.

FIG. 5 is a partial sectional view of the bleed orifice valve shown in FIG. 4 in a draft mode.

FIG. 6 is a partial sectional view of the bleed orifice valve shown in FIG. 4 in a buff mode.

FIG. 7 is a front view of a poppet of the bleed orifice valve shown in FIG. 4.

FIG. 8 is a rear view of the poppet shown in FIG. 7.

FIG. 9 is a partial sectional view of the cushioning device in a passive draft stage.

FIG. 10 is a partial sectional view of the cushioning device in a full buff stage after a buff impact.

### DETAILED DESCRIPTION OF THE INVENTION

Embodiments described herein allow for a self cleaning bleed orifice valve for a railcar cushioning device. The bleed orifice valve restricts fluid flow therethrough to control a return stroke of a piston of the railcar cushioning device. The bleed orifice valve is flushed clean during a buff mode, such as when a buff impact occurs. The bleed orifice valve changes a size of the fluid flow path therethrough during different modes or conditions. For example, during buff impact (or draft impact), the fluid flow path may be larger through the bleed orifice valve. During a bleeding mode, the fluid flow path is smaller or restricted. When the fluid flow path is larger, debris or contaminants that might have blocked the fluid flow path are flushed away. The bleed orifice valve may allow fluid flow in two directions. Under normal conditions, the bleed orifice valve allows restricted fluid flow therethrough. Under flushing conditions, the fluid flow is in an opposite direction allowing debris or contaminants that might have blocked the fluid flow path to be flushed away.

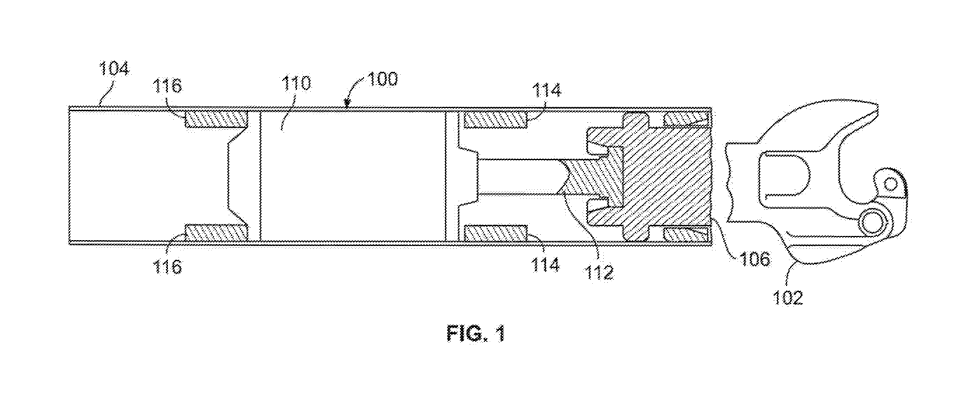

FIG. 1 illustrates a railcar cushioning device 100 formed in accordance with an exemplary embodiment. The cushioning device 100 is a self-positioning cushioning unit that uses hydraulic pressure to neutralize a coupler 102 of the railcar. The cushioning device 100 is mounted in one end of a center sill 104 of the railcar. The outer end of the sill 104 may be flared to permit swinging of a yoke 106 attached to the coupler 102.

In an exemplary embodiment, the cushioning device 100 includes a hydraulic cylinder 110 to provide cushioning for buff or draft forces on the coupler 102. Optionally, the hydraulic cylinder 110 may hold hydraulic oil and pressurized gas. A piston 112 is received in the cylinder 110. The piston 112 is coupled to the yoke 106, which extends outwardly from the sill 104 to the knuckle coupler 102.

The cylinder 110 is held in place in a pocket formed in the sill 104, such as between opposed pairs of stop blocks 114, 116. The stop blocks 114, 116 hold the cylinder 110 against movement along the sill 104. The piston 112 moves relative to the cylinder 110 with the yoke 106 and coupler 102. In alternative embodiments, the cylinder 110 may be movable linearly with respect to the sill 104.

Optionally, the cushioning device 100 may include an active draft component in addition to the hydraulic cylinder 110 to cushion the buff and/or draft forces on the coupler 102. For example, the cushioning device 100 may include a spring assembly (not shown) between the piston 112 and the coupler 102. Optionally, the spring assembly may be received within the cylinder 110 and act directly on the piston 112.

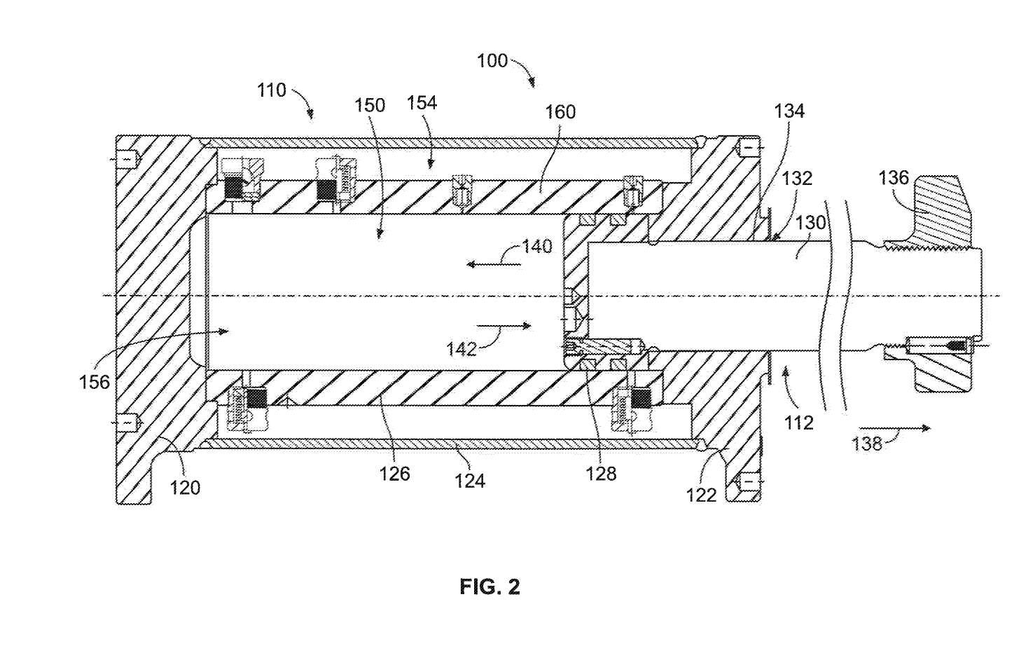

FIG. 2 is a cross sectional view of the railcar cushioning device 100 showing the cylinder 110 and the piston 112. The piston 112 is illustrated in a neutral position. Buff impacts and draft impacts move the piston 112 within the cylinder 110. Pressurized hydraulic fluid in the cylinder 110 cushions movement of the piston 112 to protect the railcars and the couplers 102 during coupling of the railcars and during train action events.

The cylinder 110 includes a rear head 120 at one end of the cylinder 110 and a front head 122 at the opposed end of the cylinder 110. The cylinder 110 includes walls defining an exterior cylinder 124 and an inner piston cylinder 126 within the exterior cylinder 124. The exterior cylinder 124 and the inner piston cylinder 126 both extend between the rear and front heads 120, 122. The exterior cylinder 124 and the inner piston cylinder 126 may be sealed against the rear and front heads 120, 122.

The piston 112 is fitted within the inner piston cylinder 126 and is movable within the inner piston cylinder 126 from a neutral position (shown in FIG. 2) between the rear and front heads 120, 122. The piston 112 is provided with sealing and bearing rings 128 engaging the interior wall of the inner piston cylinder 126. A piston rod 130 is joined to the piston 112 and extends forwardly from the cylinder 110 through an opening 132 in the front head 122. High pressure seals 134 are provided in the opening 132 to prevent leaking of the pressurized fluid from the cylinder 110. An enlarged mounting element or head 136 is provided on the free end of the piston rod 130 for mounting to the yoke 106 (shown in FIG. 1).

In an exemplary embodiment, in the neutral or resting position, the piston 112 abuts against the front head 122. The pressure of the fluid against the piston 112 forces the piston 112 in a return direction, shown generally by arrow 138, to return the piston 112 to the neutral position. In alternative embodiments, the piston 112 may be held away from the front head 122 when in the neutral position. Buff forces acting on the piston 112 force the piston in a buff direction, shown generally by the arrow 140, to a buff position which is rearward of the neutral position. Buff forces that are greater than the pressure of the fluid acting on the piston 112 force the piston 112 to move along a buff stroke in the buff direction 140. From a buff position (e.g. a position rearward of the neutral position), the piston 112 is returned along a return stroke to the neutral position by the pressure of the fluid acting on the piston 112. The return stroke is controlled and gradual by use of bleed apertures and bleed valves that allow fluid forward of the piston 112 to be expelled and returned to an area rearward of the piston 112.

In an exemplary embodiment, when the piston 112 is in a buff position (e.g. rearward of the neutral position), the railcar cushioning device 100 accommodates cushioning draft forces, such as draft impacts. Draft forces acting on the piston 112 force the piston in a draft direction, shown generally by the arrow 142. Fluid in the inner piston cylinder 126 may fill the area between the front of the piston 112 and the front head 122. Such fluid provides cushioning during draft impacts. The piston 112 may be forced in the draft direction until the piston 112 engages the front head 122.

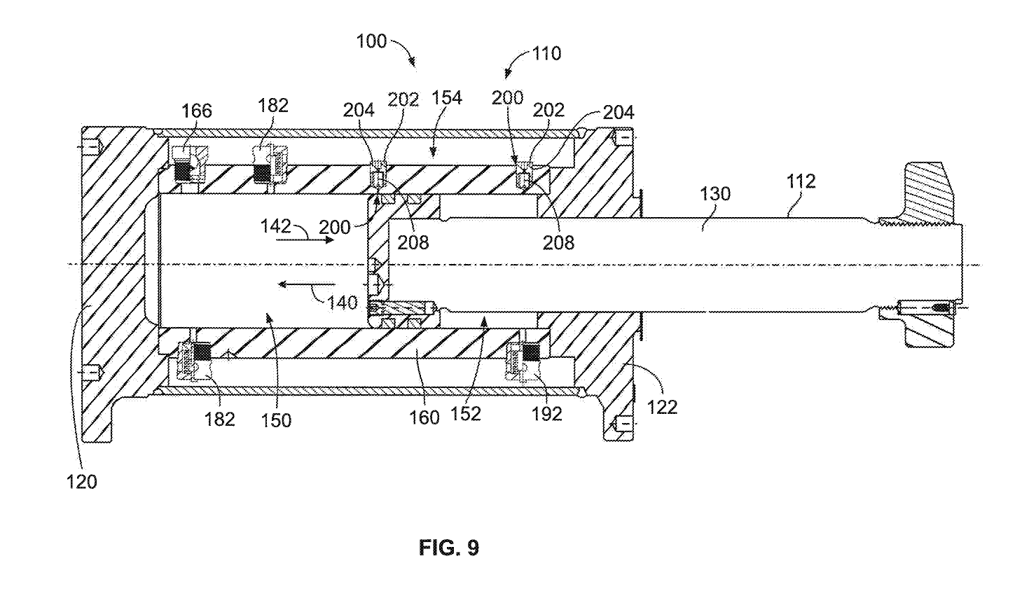

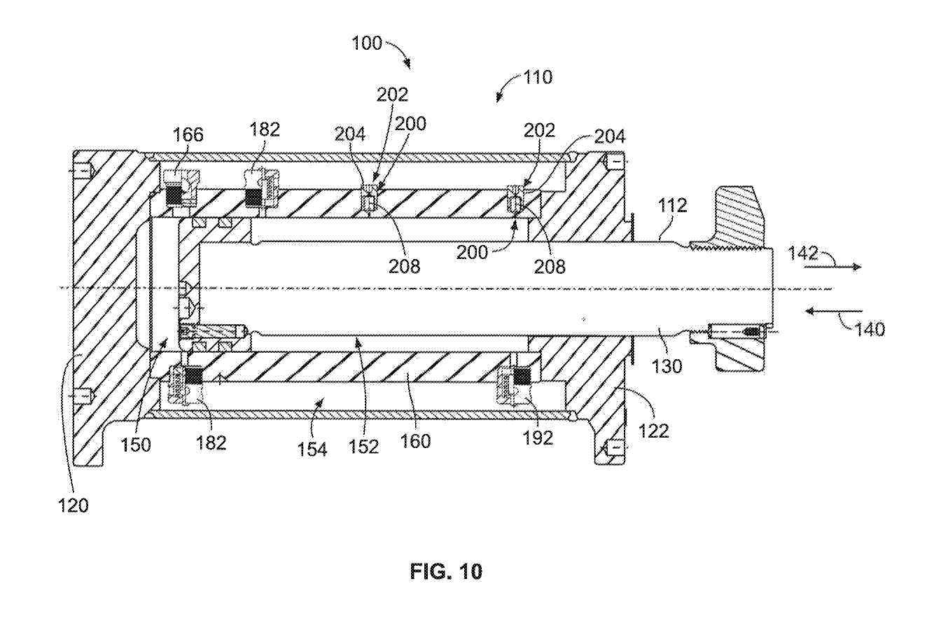

The inner piston cylinder 126 includes a high pressure chamber 150 and a low pressure chamber 152 (better illustrated in FIGS. 9 and 10). The piston 112 divides the inner piston cylinder 126 into the high pressure chamber 150 and the low pressure chamber 152. The high pressure chamber 150 is defined between the rear head 120 and the piston 112. The low pressure chamber 152 is defined between the front head 122 and the piston 112. In an exemplary embodiment, the high pressure chamber 150 is cylindrical in shape and the low pressure chamber is annular in shape, defined at least in part by the piston rod 130. The size (e.g. volume) of the chambers 150, 152 changes as the piston 112 is moved within the inner piston cylinder. The pressurized fluid as able to flow into and out of the chambers 150, 152 during operation of the cushioning device 100. The flow of the pressurized fluid is controlled to control the amount of cushioning and reduce the effects of buff and draft forces. Optionally, the high pressure chamber 150 or the low pressure chamber 152 may have a volume of approximately zero. For example, in the neutral position, the piston 112 may be positioned at the front head 122 and the low pressure chamber 152 may have a volume of approximately zero. When the piston 112 is in the fully extended or full buff position, the piston 112 may be positioned at the rear head 120 and the high pressure chamber 152 may have a volume of approximately zero.

The cylinder 110 includes an annular reservoir chamber 154 located between the exterior cylinder 124 and the inner piston cylinder 126. The reservoir chamber 154 extends between the rear and front heads 120, 122. The reservoir chamber 154 is in fluid communication with both the high pressure chamber 150 and the low pressure chamber 152. The pressurized fluid is able to flow from the high pressure chamber 150 to the low pressure chamber 152, and vice versa, through the reservoir chamber 154.

The chambers 150, 152, 154 are charged with a fluid mixture of hydraulic oil and high pressure nitrogen gas. Sufficient hydraulic oil is charged into the cylinder to completely fill the chambers 150, 152 and/or 154 with oil and nitrogen gas. Buff or draft movement of the piston 112 in the cylinder 110 mixes the nitrogen with the hydraulic oil to form a froth that fills the chambers 150, 152, 154. The nitrogen may be charged at any reasonable pressure, such as 500 p.s.i. Movement of the piston 112 in the cylinder 110 flows the hydraulic fluid between the various chambers 150, 152, 154 through a number of valves, which control such flow.

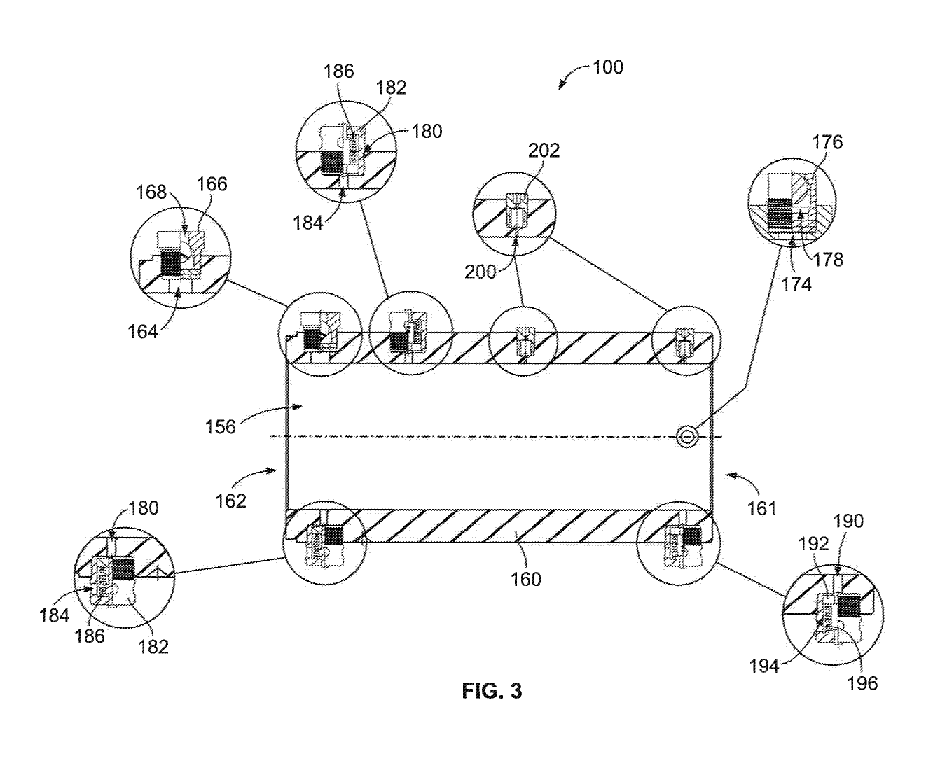

The cylinder 100 includes a cylinder body 160 forming the wall defining the inner piston cylinder 126 and separating the reservoir chamber 154 from the high and low pressure chambers 150, 152, which may be collectively referred to as the inner chamber 156. The cylinder body 160 has openings therethrough between the inner chamber 156 and the reservoir chamber 154. Flow paths are defined through the openings. Valves are provided in the openings to control fluid flow through the flow paths. For example, the valves may be one-way check valves, spring-backed flow control valves, pressure relief valves, bleed orifice valves or other types of valves. The valves are described in further detail with respect to FIG. 3.

FIG. 3 is a partial sectional view of a portion of the cushioning device 100. FIG. 3 illustrates the cylinder body 160 with enlarged views of various valves for use with the cushioning device 100 for controlling fluid flow within the cushioning device 100. The cylinder body 160 extends between a low pressure end 161 at the front of the cylinder body 160 and a high pressure end 162 at a rear of the cylinder body 160.

The cylinder body 160 includes at least one high pressure check valve opening 164 in fluid communication with the high pressure chamber 150 (shown in FIG. 2). A high pressure check valve 166 is received in the opening 164. The check valve 166 allows and restricts flow through a fluid flow path 168 defined through the check valve 166 depending on an activation condition. For example, the check valve 166 may be a one way check valve that allows fluid flow in one direction and restricts fluid flow in the opposite direction. The check valve 166 may be a ball valve. The check valve 166 may open or close based on small pressure differentials between the high pressure chamber 150 and the reservoir chamber 154 (shown in FIG. 2). In the illustrated embodiment, the check valve 166 allows flow from the reservoir chamber 154 into the inner chamber 156. The check valve 166 restricts flow from the inner chamber 156 into the reservoir chamber 154. Any pressure differential between the inner chamber 156 and the reservoir chamber 154 may be enough to activate the check valve 166, thus opening or closing the check valve 166 depending on which side has a higher pressure. In an exemplary embodiment, the check valve 166 permits free flow of fluid from the reservoir chamber 154 into the high pressure chamber 150 during movement of the piston 112 toward the front head 122 (shown in FIG. 2), such as when the piston 112 is returning to the neutral position. During movement of the piston 112 toward the rear head 120 (e.g. buff impact), the check valve 166 closes to prevent flow of hydraulic fluid through the fluid flow path 168 from the high pressure chamber 150 into the reservoir chamber 154.

The cylinder body 160 includes at least one low pressure check valve opening 174 in fluid communication with the low pressure chamber 152 (shown in FIGS. 9 and 10). A low pressure check valve 176 is received in the opening 174. The check valve 176 allows and restricts flow through a fluid flow path 178 defined through the check valve 176 depending on an activation condition. For example, the check valve 176 may be a one way check valve that allows fluid flow in one direction and restricts fluid flow in the opposite direction. The check valve 176 may be a ball valve. The check valve 176 may open or close based on small pressure differentials between the low pressure chamber 152 and the reservoir chamber 154. In the illustrated embodiment, the check valve 176 allows flow from the reservoir chamber 154 into the inner chamber 156. The check valve 176 restricts flow from the inner chamber 156 into the reservoir chamber 154. Any pressure differential between the inner chamber 156 and the reservoir chamber 154 may be enough to activate the check valve 176, thus opening or closing the check valve 176 depending on which side has a higher pressure. In an exemplary embodiment, the check valve 176 permits free flow of fluid from the reservoir chamber 154 into the low pressure chamber 152 during movement of the piston 112 toward rear head 120 (shown in FIG. 2), such as during a buff impact. During movement of the piston 112 toward the front head 122 (e.g. piston 112 returning to neutral), the check valve 176 closes to prevent flow of hydraulic fluid through the fluid flow path 178 from the low pressure chamber 152 into the reservoir chamber 154.

The cylinder body 160 includes at least one high pressure buff valve opening 180 in fluid communication with the high pressure chamber 150. A high pressure buff valve 182 is received in the opening 180. The buff valve 182 allows and restricts flow through a high pressure fluid flow path 184 defined through the buff valve 182 depending on an activation condition. For example, the buff valve 182 may be a pressure relief valve that allows fluid flow through the valve when the pressure of the fluid exceeds a predetermined or threshold amount. The threshold pressure may be adjustable or controllable by adjusting the valve or selecting a valve having a particular threshold pressure release.

In an exemplary embodiment, the buff valve 182 is a spring biased pressure relief valve. The buff valve 182 is biased by a spring 186 toward the orifice to normally close the orifice. The pressure at which the buff valve 182 releases may be controlled by selecting a buff valve 182 having a certain spring force holding the valve closed. The buff valve 182 may only allow flow in one direction and restricts fluid flow in the opposite direction. In the illustrated embodiment, the buff valve 182 allows flow from the inner chamber 156 into the reservoir chamber 154. The buff valve 182 restricts flow from the reservoir chamber 154 into the inner chamber 156. In an exemplary embodiment, the buff valve 182 permits flow of fluid from the high pressure chamber 150 during buff impacts (e.g. high buff forces, such as during coupling of railcars and some train actions), however the buff valves 182 may remain closed during occurrence of low buff forces (e.g. during some train actions), until the threshold is exceeded. During movement of the piston 112 toward the front head 122, such as when the piston 112 is returning to the neutral position, the buff valves 182 remain closed to prevent flow of hydraulic fluid through the fluid flow path 184 from the reservoir chamber 154 into the high pressure chamber 150.

The cylinder body 160 includes at least one low pressure draft valve opening 190 in fluid communication with the low pressure chamber 152. A low pressure draft valve 192 is received in the opening 190. The draft valve 192 allows and restricts flow through a low pressure fluid flow path 194 defined through the draft valve 192 depending on an activation condition. For example, the draft valve 192 may be a pressure relief valve that allows fluid flow through the valve when the pressure of the fluid exceeds a predetermined or threshold amount. The threshold pressure may be adjustable or controllable by adjusting the valve or selecting a valve having a particular threshold pressure release.

In an exemplary embodiment, the draft valve 192 is a spring biased pressure relief valve. The draft valve 192 is biased by a spring 196 toward the orifice to normally close the orifice. The pressure at which the draft valve 192 releases may be controlled by selecting a draft valve 192 having a certain spring force holding the valve closed. The draft valve 192 may only allow flow in one direction and restricts fluid flow in the opposite direction. In the illustrated embodiment, the draft valve 192 allows flow from the inner chamber 156 into the reservoir chamber 154. The draft valve 192 restricts flow from the reservoir chamber 154 into the inner chamber 156. In an exemplary embodiment, the draft valve 192 permits flow of fluid from the low pressure chamber 152 during draft impacts (e.g. high draft forces, such as during some train actions, such as elevation changes from downhill to uphill), however the draft valves 192 may remain closed during occurrence of low draft forces (e.g. during some train actions). During movement of the piston 112 toward the rear head 120, such as during buff impact, the draft valves 192 remain closed to prevent flow of hydraulic fluid through the fluid flow path 194 from the reservoir chamber 154 into the low pressure chamber 152.

The cylinder body 160 includes at least one bleed valve opening 200 in fluid communication with the inner chamber 156 and the reservoir chamber 154. A bleed orifice valve 202 is received in the opening 200. The bleed orifice valve 202 allows flow through a bleed flow path 206 defined through the bleed orifice valve 202. The bleed orifice valve 202 allows bleed flow of the fluid from the inner chamber 156 to the reservoir chamber 154 for controlled movement of the piston 112 in the inner chamber 156. For example, the bleed flow of the fluid allows the piston 112 to slowly return forwardly to the neutral position or to slowly progress rearwardly from the neutral position depending on the amount of force on the coupler 102 (shown in FIG. 1).

In the illustrated embodiment, two bleed orifice valves 202 are utilized. The bleed orifice valves 202 are axially offset, with one being positioned further forward and the other being positioned further rearward. The rearward bleed orifice valve 202 allows both forward and reverse bleed flow therethrough for controlled piston 112 movement in both the buff and draft directions. As such, the piston 112 is allowed to slowly move rearward or forward when forces on the piston 112 are less than the forces required to open the buff valve 182 or the draft valve 192 (e.g. impact forces). The bleed orifice valves 202 allow bleed flow therethrough until the bleed openings 200 are covered by the piston 112. As such, when the piston 112 covers the rearward bleed opening 200, the rearward movement of the piston 112 is stopped until a buff impact occurs to open the buff valve 182.

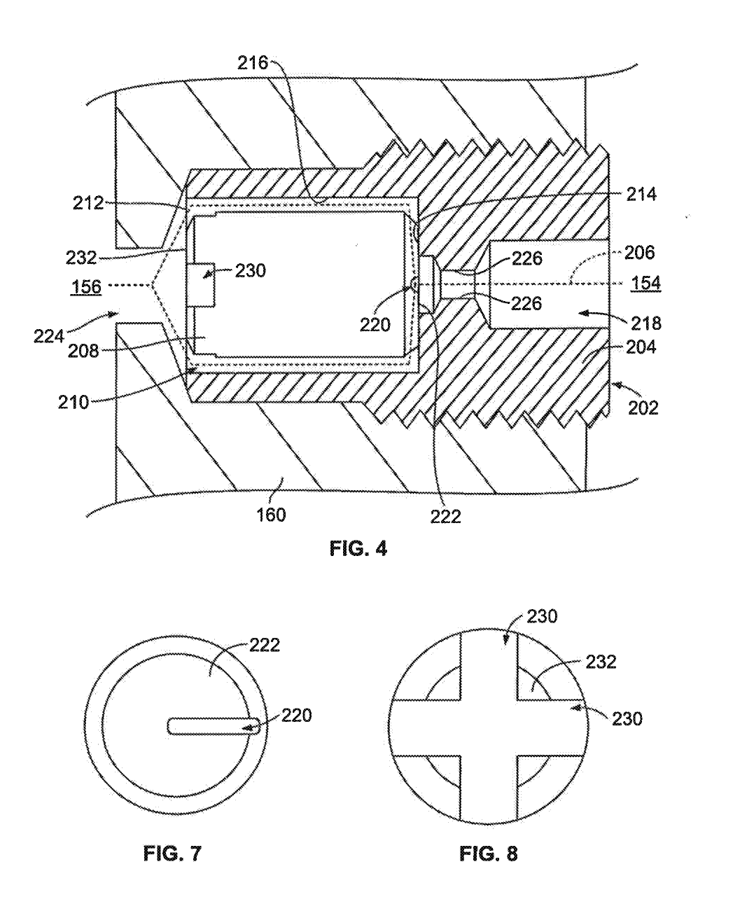

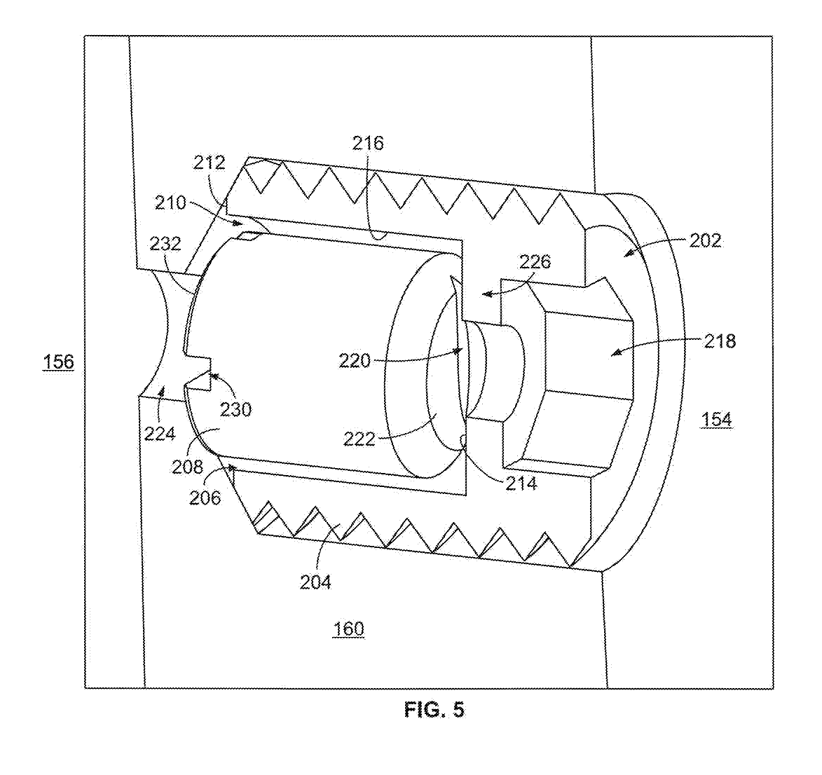

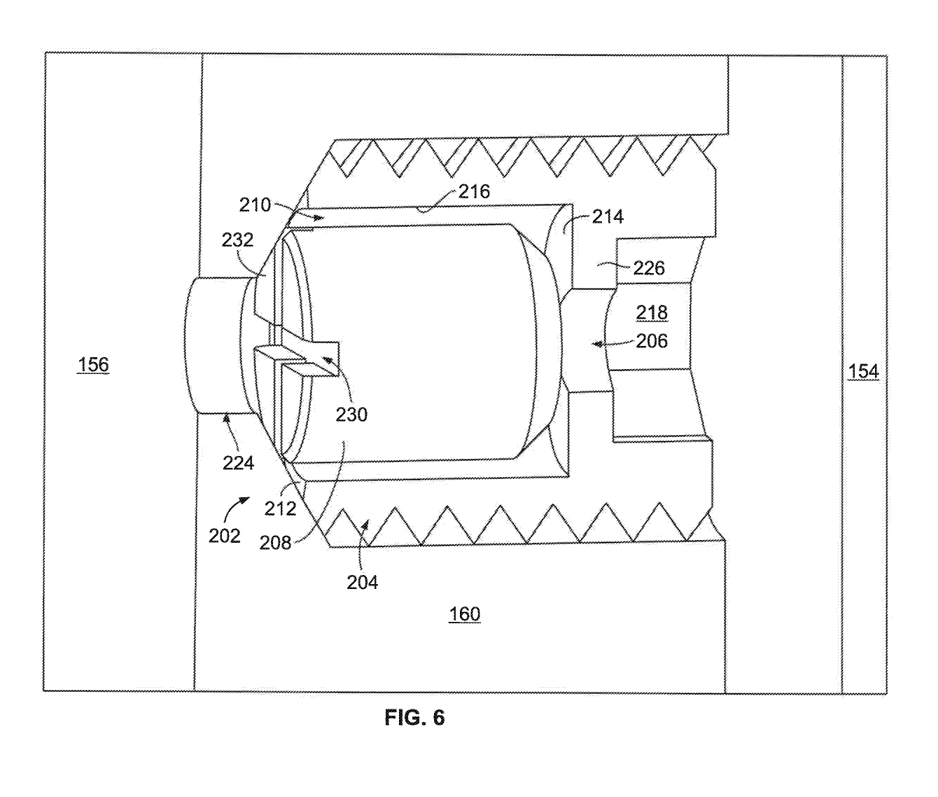

FIG. 4 is a cross sectional view of the bleed orifice valve 202. FIG. 5 is a partial sectional view of the bleed orifice valve 202 in a draft mode (e.g. normal mode). FIG. 6 is a partial sectional view of the bleed orifice valve 202 in a buff mode (e.g. cleaning mode). The bleed orifice valve 202 includes a valve housing 204 having a bleed flow path 206 therethrough. The valve housing 204 is held in the cylinder body 160. Optionally, the valve housing 204 may be threadably coupled to the cylinder body 160. The bleed flow path 206 extends between the inner chamber 156 and the reservoir chamber 154. The bleed orifice valve 202 controls bleed flow of the fluid from the inner chamber 156 to the reservoir chamber 154.

The bleed orifice valve 202 has a poppet 208 received in the valve housing 204. The poppet 208 is movable within a poppet cavity 210 in the valve housing 204 to control flow through the bleed flow path 206. In an exemplary embodiment, the bleed orifice valve 202 is self-cleaning and is able to flush contaminants or debris caught in the bleed flow path 206, such as during buff impacts where the pressurized fluid is forced through the bleed orifice valve 202.

The poppet cavity 210 has an open end 212 at an end of the valve housing 204. The valve housing 204 has a midwall 214 at an opposite end of the poppet cavity 210 from the open end 212. The valve housing 204 has a wall 216 extending between the open end 212 and the midwall 214 that defines a radially outer surface of the poppet cavity 210. The poppet cavity 210 is sized larger than the poppet 208 to allow the poppet 208 to move (e.g. radially) within the poppet cavity 210. The poppet 208 may self-center within the poppet cavity 210. The poppet 208 may be unintentionally forced toward the wall 216, such as when debris or contaminants pass through the bleed flow path 206.

The bleed orifice valve 202 includes a valve channel 218 extending between the poppet cavity 210 and the end of the valve housing 204 proximate to the reservoir chamber 154. The bleed flow flows from the poppet cavity 210, around the poppet 208 and into the valve channel 218.

The poppet 208 is able to move axially in the poppet cavity 210 to increase or decrease flow through the bleed flow path 206. For example, in a draft mode, the poppet 208 may be forced against the midwall 214 during normal use of the cushioning device 100 to allow bleed flow through the bleed orifice valve 202 from the inner chamber 156 to the reservoir chamber 154. In a buff mode, the poppet 208 is forced away from the midwall 214 during buff impacts when the pressurized fluid is forced from the reservoir chamber 154 into the inner chamber 156.

The amount of flow through the bleed flow path 206 may be different in the draft mode than in the buff mode. For example, in the draft mode, the flow may be restricted by the poppet 208, while in the buff mode, the flow may be unrestricted (or less restricted) by the poppet 208. In an exemplary embodiment, a small amount of flow is able to flow past the poppet 208 in the draft mode, while a larger amount of flow is able to flow past the poppet 208 in the buff mode.

The high pressure of the fluid in the buff direction forces the poppet 208 to move away from the midwall 214, enlarging the size of the bleed flow path 206 to allow a higher fluid flow through the bleed orifice valve 202 and allowing fluid flow in the opposite direction. Such fluid flow flushes debris and contaminants that may be stuck between the poppet 208 and the valve housing 204 to clean the bleed orifice valve 202.

FIG. 7 is a front view of the poppet 208. The poppet 208 includes an orifice channel 220 formed in a front wall 222 of the poppet 208. The orifice channel 220 allows fluid flow along the front wall 222 from around the sides of the poppet 208.

The size (e.g. width and depth) of the orifice channel 220 may be selected to control the bleed flow rate through the bleed orifice valve 202. For example, with additional reference to FIGS. 4-6, when the front wall 222 is held against the midwall 214, the orifice channel 220 defines the only path through the bleed orifice valve 202 for the fluid to travel. The fluid flows through a small orifice 224 at the end of the bleed valve opening 200 proximate to the inner chamber 156. The small orifice 224 is sized to stop debris or contaminants of a certain size from flowing into the poppet cavity 210. The fluid flows around all of the sides of the poppet 208 to the orifice channel 220. The fluid flows through the orifice channel 220 to the valve channel 218.

In an exemplary embodiment, the valve channel 218 has a restrictor 226 that restricts the size of the valve channel 218 to stop debris or contaminants of a certain size from flowing into the poppet cavity 210. Optionally, the restrictor 226 and the small orifice 224 may be sized similar. For example, the restrictor 226 and the small orifice 224 may be approximately 1/16″ holes. Other sized holes are possible in alternative embodiments. The size of the orifice channel 220 may be smaller than the size of the restrictor 226 and the small orifice 224. For example, the orifice channel 220 may have a radius of approximately 0.015″. Other sized orifice channels 220 are possible in alternative embodiments. Because the orifice channel 220 is smaller than the restrictor 226 and the small orifice 224, it is possible for debris or contaminants to pass through the restrictor 226 or the small orifice 224 but not through the orifice channel 220. The flushing action that occurs during the buff impacts, when the fluid flow direction is reversed, clears the debris from the orifice channel 220.

FIG. 8 is a rear view of the poppet 208. The poppet 208 includes slots 230 formed in a rear wall 232 of the poppet 208. The slots 230 allow fluid flow between the sides of the poppet 208 and the rear wall 232. Any number of slots 230 may be provided. The slots 230 may be in fluid communication with each other. The size (e.g. width and depth) of the slots 230 may be larger than the size of the orifice channel 220 (shown in FIG. 7) to allow higher flow than the more restrictive orifice channel 220. With additional reference to FIG. 6, when the rear wall 232 is held against the opening 200 (e.g. during a buff impact), the slots 230 define a flow path through the bleed orifice valve 202 for the fluid to travel. The fluid flows through the valve channel 218, along the sides of the poppet 208 and through the slots 230 to the small orifice 224. The slots 230 are large enough that any contaminants or debris can flow to the small orifice 224.

FIG. 9 is a partial sectional view of the cushioning device 100 in a passive draft stage. FIG. 10 is a partial sectional view of the cushioning device 100 in a full buff stage after a buff impact. Reference is also made to FIG. 2 which illustrates the cushioning device in the neutral stage. The pressure of the fluid tends to force the piston 112 to the neutral position. Buff forces or draft forces acting on the coupler 102 (shown in FIG. 1) tend to force the piston 112 in the buff direction 140 or in the draft direction 142. In the illustrated embodiment, from the neutral position, the piston 112 can only move in the buff direction 140 and cannot move in the draft direction 142. However, when the piston 112 is not in the neutral position, such as after some buff forces or impacts have moved the piston 112 rearwardly, the piston 112 can move in the draft direction to cushion draft forces or draft impacts. In other embodiments, the neutral position may be positioned partially rearward of the front head 122 to allow cushioning of draft impacts from the neutral position.

The piston 112 is held in the neutral position (FIG. 2) by the pressure of the hydraulic fluid acting on the large area rear face of the piston 112. The pressurized fluid exerts a predetermined force biasing the piston 112 toward the front head 122. In an exemplary embodiment, from the neutral position the cushioning device 100 has a maximum buff stroke of approximately 10 inches from the neutral position before the piston 112 engages the rear head 120. The maximum buff stroke may be longer or shorter in alternative embodiments. In an exemplary embodiment, when the piston 112 is in the passive draft position (FIG. 9), the piston 112 has a maximum draft stroke of approximately 2 inches before the piston 112 engages the front head 122. The maximum draft stroke may be longer or shorter in alternative embodiments. The maximum draft stroke may be controlled by the positioning of the bleed orifice valve 202 relative to the front head 122. In the passive draft position, the piston 112 covers the bleed valve openings 200 and the bleed orifice valves 202 (two of them in the illustrated embodiment, however more or less may be provided in alternative embodiments). The piston 112 may be moved to the passive draft position by buff forces imparted on the coupler 102, such as from train actions, such as elevation changes (e.g. traveling downhill). At least one of the bleed orifice valves 202, such as the rearward bleed orifice valve 202, may allow fluid flow therethrough as the piston 112 is forced rearwardly in the buff direction. The forces on the piston 112 may be less than the forces required to open the high pressure buff valves 182, so the high pressure buff valves 182 remain closed, but fluid is able to bleed through the bleed orifice valve 202 allowing the piston 112 to move to the passive draft position. Once the bleed orifice valves 202 are covered by the piston 112, no further bleeding through the bleed orifice valve 202 occurs and the piston 112 remains at the passive draft position. From the passive draft position, when the forces are high enough to open the buff or draft valves 182, 192, the piston 112 is able to move forward (e.g. toward the neutral position of FIG. 2) or rearward (e.g. toward the full buff position of FIG. 10) to cushion buff or draft impacts.

When the coupler 102 is impacted in the buff direction, the resultant force is transmitted to the piston 112. The piston 112 does not move along the buff stroke until the coupler force exceeds a predetermined amount, such as 75,000 pounds static force, that is required to open the buff valves 182 and permit hydraulic fluid to flow from the high pressure chamber 150. When the coupler force exceeds the threshold force, the cracking pressure for the buff valves 182 is exceeded, the buff valves 182 open, and the piston 112 moves toward the rear head 120. The extent to which the buff valves 182 are opened depends upon the energy of the impact. Low energy impacts open the valves partially to permit relatively low speed movement of the piston 112 toward the rear head 120. High energy impacts fully open the buff valves 182 and permit the piston 112 to move more rapidly toward the rear head 120. The hydraulic compression force resulting from flowing hydraulic fluid out through the open buff valves 182 depends upon the open area of the flow orifices through the buff valves 182.

During buff collapse of the piston 112, the hydraulic fluid is forced from the high pressure chamber 150 into the reservoir chamber 154 and then into the low pressure chamber 152. The fluid flow from the reservoir chamber 154 into the low pressure chamber 152 occurs through the bleed orifice valve(s) 202. The fluid flow through the bleed orifice valve(s) 202 during such buff mode is in a reverse direction from the normal bleed flow, which causes the poppet 208 to move within the valve housing 204 away from the midwall 214 (shown in FIG. 4). Such flow through the bleed orifice valve(s) 202 flushes debris or contaminants from the bleed orifice valve(s) 202. In the buff mode, the bleed orifice valve(s) 202 are self-cleaned.

Optionally, during buff collapse of the piston 112, the interior volume of the cylinder 110 is decreased by the volume of piston rod 130 extended into the cylinder 110. The decrease in volume increases the gas pressure and increases the static pressure resisting movement of the piston 112 toward rear head 120 to help slow the buff stroke.

The maximum orifice areas for the buff valves 182 and the placement of the buff valves 182 along the length of the cylinder body 160 (e.g. the buff valves 182 may be staggered axially along the length of the cylinder such that the piston 112 may successively cover the buff valves 182 as the piston 112 progresses in the buff direction) may be chosen to maintain an essentially constant hydraulic compression force along the buff stroke. The relatively high, uniform hydraulic compression force for the cushioning device 100 assures impact energy is efficiently absorbed during the buff stroke and motion of the coupler 102 in the buff direction is smoothly and safely slowed to protect the railcar from high inertia accelerations. During the buff stroke, hydraulic fluid is flowed from the high pressure chamber 150 into the reservoir chamber 154 through the buff valves 182 and from the reservoir chamber 154 into the low pressure chamber 152 through the low pressure check valve 176 (shown in FIG. 3).

After huff movement stops, the gas pressure force on the rear face of the piston 112 slowly returns the piston 112 to the neutral position. At this time, bleed flow through the bleed orifice valves 202 controls the return stroke of the piston 112 in a slow and steady manner. The high pressure check valves 166 open to permit hydraulic fluid to flow from reservoir chamber 154 into the high pressure chamber 150. The low pressure check valve 176 and the huff and draft valves 182, 192 are closed. hydraulic fluid in the low pressure chamber 152 is pressurized and flows out from the low pressure chamber 152 initially through both bleed orifice valves 202 and then through the forward bleed orifice valve 202 only when the rearward bleed orifice valve 202 is covered. The pressure of the hydraulic fluid continues to move the piston 112 toward the neutral position until huff forces hold the piston in the passive draft position or until the piston 112 engages the front head 122.

Buff and draft impacts on the coupler 102 during normal operation are cushioned by the cushioning device 100. Very high energy impacts may fully collapse the device in buff or draft, leaving residual unabsorbed energy. The residual energy is dissipated by bottoming contact with stop blocks or by using other devices, such as springs to cushion further forces. While residual energy bottoming can injure the railcar, efficient energy absorption by the cushioning device 100 reduces the likelihood of injury. Very high energy impacts are infrequent.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A railcar cushioning device comprising:
a piston being coupled to a coupler of a railcar, the piston being movable from a neutral position;
a hydraulic cylinder holding pressurized fluid, the cylinder having a cylinder body, the cylinder having an inner chamber interior of the cylinder body and a reservoir chamber exterior of the cylinder body, the piston being positioned in the inner chamber, the cylinder body having a fluid flow path therethrough allowing fluid flow from the inner chamber to the reservoir chamber as the piston is moved from the neutral position, the cylinder body having a bleed opening therethrough allowing bleed flow from the inner chamber to the reservoir chamber as the piston returns to the neutral position; and
a bleed orifice valve received in the bleed opening, the bleed orifice valve having a valve housing having a bleed flow path therethrough, the bleed orifice valve having a poppet received in the valve housing, the poppet moving to allow and restrict fluid flow through the bleed flow path based on the pressure of the fluid in the inner chamber and the reservoir chamber, the poppet having an orifice channel allowing a restricted fluid flow through the valve housing when the pressure in the inner chamber is greater than the pressure in the reservoir chamber.

2. The railcar cushioning device of claim 1, wherein the rate of bleed flow through the valve housing is controlled by the size of the orifice channel.

3. The railcar cushioning device of claim 1, wherein, in a draft mode, the poppet abuts against a midwall of the valve housing such that the orifice channel is the only flow path through the valve housing, and wherein, in a buff mode, the poppet is positioned away from the midwall increasing the size of the bleed flow path to allow greater flow through the bleed orifice valve.

4. The railcar cushioning device of claim 1, wherein, in a draft mode, the bleed flow is in a direction from the inner chamber to the reservoir chamber and is restricted, and wherein, in a buff mode, the fluid flow through the bleed orifice valve is in an opposite direction from the reservoir chamber to the inner chamber.

5. The railcar cushioning device of claim 1, wherein the bleed orifice valve is self-cleaning during buff impacts by reversing the fluid flow direction through the valve housing and increasing the size of the bleed flow path to flush debris from the valve housing.

6. The railcar cushioning device of claim 1, wherein the valve housing includes a poppet cavity having a midwall at an end of the poppet cavity, the poppet having a front end with the orifice channel formed in the front end, in a draft mode, the pressure of the fluid forces the front end against the midwall such that the orifice channel defines the only flow path through the valve housing, in a buff mode, the pressure of the fluid forces the poppet away from the midwall to flush debris from the orifice channel.

7. The railcar cushioning device of claim 1, wherein the piston is positioned forward of the bleed orifice valve when the piston is in the neutral position, the bleed orifice valve allows reverse bleed flow therethrough to allow the piston to move in a buff direction until the piston covers the bleed opening.

8. The railcar cushioning device of claim 1, further comprising a second bleed opening and a second bleed orifice valve in the second bleed opening, the bleed orifice valves being axially offset.

9. A railcar cushioning device for cushioning both buff and draft impacts, the cushioning device comprising:
a cylinder having a rear head at one cylinder end and a front head at an opposed cylinder end, the cylinder having walls defining an exterior cylinder and an inner piston cylinder within the exterior cylinder;
a piston located in the inner piston cylinder and movable from a neutral position between the heads;
the cylinder having a high pressure chamber in the inner piston cylinder between the piston and the rear head and a low pressure chamber in the inner piston cylinder between the piston and the front head, the piston separating the high and low pressure chambers;
the cylinder having a reservoir chamber between the inner piston cylinder and the exterior cylinder, the reservoir chamber being in fluid communication with both the high pressure chamber and the low pressure chamber;
pressurized fluid allowed to flow in the chambers, the pressurized fluid normally holding the piston in the neutral position;
a high pressure fluid flow path between the high pressure chamber and the reservoir chamber, a buff valve in the high pressure fluid flow path, the pressurized fluid moving through the high pressure fluid flow path when a buff impact occurs;
a low pressure fluid flow path between the low pressure chamber and the reservoir chamber, a draft valve in the law pressure fluid flow path controlling fluid flow through the low pressure fluid flow path; and
a bleed flow path between the low pressure chamber and the reservoir chamber, a bleed orifice valve in the bleed flow path, the fluid moving through the bleed flow path after the buff impact occurs as the piston returns to the neutral position, the bleed orifice valve having a poppet movable within a valve housing control flow of the fluid through the valve housing.

10. The railcar cushioning device of claim 9, wherein forces on the piston cause the piston to move in a buff direction toward the rear head and in a draft direction toward the front head, the bleed orifice valve allowing flow in a first direction when the piston moves in the buff direction and the bleed orifice valve allows flow in a second direction opposite the first direction when the piston moves in the draft direction.

11. The railcar cushioning device of claim 9, wherein the bleed orifice valve allows bleed flow when the buff valve and the draft valve are closed.

12. The railcar cushioning device of claim 9, wherein when the buff valve opens, the fluid flows through the bleed orifice valve in an opposite direction to flush the bleed orifice valve.

13. The railcar cushioning device of claim 9, wherein the poppet has an orifice channel allowing a restricted fluid flow through the valve housing when the pressure in the low pressure chamber is greater than the pressure in the reservoir chamber, the rate of bleed flow through the valve housing is controlled by the size of the orifice channel.

14. The railcar cushioning device of claim 9, wherein, in a draft mode, the poppet abuts against a midwall of the valve housing such that an orifice channel along a front of the poppet is the only flow path through the valve housing, and wherein, in a buff mode, the poppet is positioned away from the midwall increasing the size of the bleed flow path to allow greater flow through the bleed orifice valve.

15. The railcar cushioning device of claim 9, wherein, in a draft mode, the bleed flow is in a direction from the low pressure chamber to the reservoir chamber and is restricted, and wherein, in a buff mode, the fluid flow through the bleed orifice valve is in an opposite direction from the reservoir chamber to the inner chamber.

16. The railcar cushioning device of claim 9, wherein the bleed orifice valve is self-cleaning during buff impacts by reversing the fluid flow direction through the valve housing and increasing the size of the bleed flow path to flush debris from the valve housing.

17. The railcar cushioning device of claim 9, wherein the valve housing includes a poppet cavity having a midwall at an end of the poppet cavity, the poppet having a front end with an orifice channel formed in the front end, in a draft mode, the pressure of the fluid forces the front end against the midwall such that the orifice channel defines the only flow path through the valve housing, in a buff mode, the pressure of the fluid forces the poppet away from the midwall to flush debris from the orifice channel.

18. The railcar cushioning device of claim 9, wherein the bleed flow path is defined between the low pressure chamber and the reservoir chamber after a buff impact and the piston is moved rearward and wherein the bleed flow path is defined between the high pressure chamber and the reservoir chamber when the piston is in the neutral position and the piston is positioned forward of the bleed orifice valve, when the piston is positioned forward of the bleed orifice valve, the bleed orifice valve allows bleed flow therethrough from the high pressure chamber to the reservoir chamber to allow the piston to move in a buff direction until the piston. covers the bleed orifice valve.

19. The railcar cushioning device of claim 9, wherein the bleed orifice valve defines a first bleed orifice valve, the railcar cushioning device further comprising a second bleed orifice valve being axially offset from the first bleed orifice valve;
in the neutral position, the first bleed orifice valve is covered by the piston and the second bleed orifice valve is in fluid communication with the high pressure chamber, the second bleed orifice valve allowing buff movement of the piston to move the piston away from the front head until the second bleed orifice valve is covered by the piston; and
after buff impact, the first and second bleed orifice valves are in fluid communication with the low pressure chamber and allow bleed flow from the low pressure chamber to the reservoir chamber to control return of the piston toward the neutral position.

20. The railcar cushioning device of claim 9, wherein the piston abuts against the front head in the neutral position.
